(19) United States
(12) Patent Application Publication
(10) Pub. No.: US 2025/0272642 A1
(43) Pub. Date: Aug. 28, 2025

(54) INFORMATION PROCESSING APPARATUS AND INFORMATION PROCESSING METHOD

(71) Applicant: NEC Corporation, Tokyo (JP)

(72) Inventors: Ruriko YAMADA, Tokyo (JP); Kaori Kawauchi, Tokyo (JP); Hiroyuki Akiyama, Tokyo (JP); Megumi Eto, Tokyo (JP); Koichi Todoroki, Tokyo (JP); Koji Ichikawa, Tokyo (JP); So Yamada, Tokyo (JP)

(73) Assignee: NEC Corporation, Tokyo (JP)

(21) Appl. No.: 19/053,546

(22) Filed: Feb. 14, 2025

(30) Foreign Application Priority Data
Feb. 26, 2024 (JP) 2024-026668

(51) Int. Cl. G06Q 10/0637; G06Q 10/30; G06Q 50/40

(52) U.S. Cl. CPC G06Q 10/0637; G06Q 10/30; G06Q 50/40

(57) ABSTRACT

An information processing apparatus of the present disclosure includes: a receiving unit that receives input of work information including information representing the details of a work that may generate waste; and an estimating unit that estimates waste generated by the work based on the work information.

### INCORPORATION BY REFERENCE

This application is based upon and claims the benefit of priority from Japanese patent application No. 2024-026668, filed on Feb. 26, 2024, the disclosure of which is incorporated herein in its entirety by reference.

### TECHNICAL FIELD

The present disclosure relates to an information processing apparatus, an information processing method, and a program.

### BACKGROUND ART

From the viewpoint of environmental protection and resource reuse, it is necessary to properly separate waste and carry out proper waste disposal. For this reason, it may be executed to grasp the details of waste and request a waste disposal vendor to dispose of the waste. Moreover, as a technique related to the disposal of waste, Patent Literature 1 describes the grasp of the recovery rate of reusable valuables contained in waste. To be specific, in Patent Literature 1, the amount of material contained in a product is calculated from the model name of the product.
Patent Literature 1: Japanese Unexamined Patent Application Publication No. JP-A 11-244836 (1999)

However, waste includes various objects and it is difficult to accurately grasp the details of waste. For this reason, there arises a problem that it is not possible to smoothly carry out waste disposal.

### SUMMARY OF THE INVENTION

Accordingly, an object of the present disclosure is to solve the abovementioned problem that it is not possible to smoothly carry out waste disposal.

An information processing apparatus as an aspect of the present disclosure includes: a receiving unit that receives input of work information including information representing details of a work that may generate waste; and an estimating unit that estimates waste generated by the work based on the work information.

Further, an information processing method as an aspect of the present disclosure is a method by an information processing apparatus, and the method includes: receiving input of work information including information representing details of a work that may generate waste; and estimating waste generated by the work based on the work information.

Further, a program as an aspect of the present disclosure includes instructions for causing a computer to execute processes to: receive input of work information including information representing the details of a work that may generate waste; and estimate waste generated by the work based on the work information.

Further, an information processing apparatus as an aspect of the present disclosure includes: a receiving unit that receives input of waste information representing details of waste; and an adopting unit that adopts a vendor to ask to dispose of the waste included by the waste information based on vendor information including information on details of business of a vendor that performs business related to disposal of waste.

Further, an information processing method as an aspect of the present disclosure is a method by an information processing apparatus, and the method includes: receiving input of waste information representing details of waste; and adopting a vendor to ask to dispose of the waste included by the waste information based on vendor information including information on details of business of a vendor that performs business related to disposal of waste.

Further, a program as an aspect of the present disclosure includes instructions for causing a computer to execute processes to: receive input of waste information representing details of waste; and adopt a vendor to ask to dispose of the waste included by the waste information based on vendor information including information on details of business of a vendor that performs business related to disposal of waste.

With the configurations as described above, the present disclosure allows for smoothly carrying out waste disposal.

### BRIEF DESCRIPTION OF DRAWINGS

FIG. 1 is a block diagram showing an overall configuration of an information processing system according to the present disclosure;

FIG. 2 is a block diagram showing a configuration of a waste estimation processing apparatus according to the present disclosure;

FIG. 3 is a block diagram showing a configuration of a waste disposal arrangement assistance apparatus according to the present disclosure;

FIG. 4 is a flowchart showing processing operation of the waste estimation processing apparatus according to the present disclosure;

FIG. 5 is a flowchart showing processing operation of the waste disposal arrangement assistance apparatus according to the present disclosure;

FIG. 6 is a block diagram showing a hardware configuration of the information processing apparatus according to the present disclosure;

FIG. 7 is a block diagram showing a configuration of the information processing apparatus according to the present disclosure; and

FIG. 8 is a block diagram showing a configuration of the information processing apparatus according to the present disclosure.

### EXAMPLE EMBODIMENTS

### First Example Embodiment

A first example embodiment of the present disclosure will be described with reference to the drawings. The drawings may be related to any example embodiment.

### [Configuration]

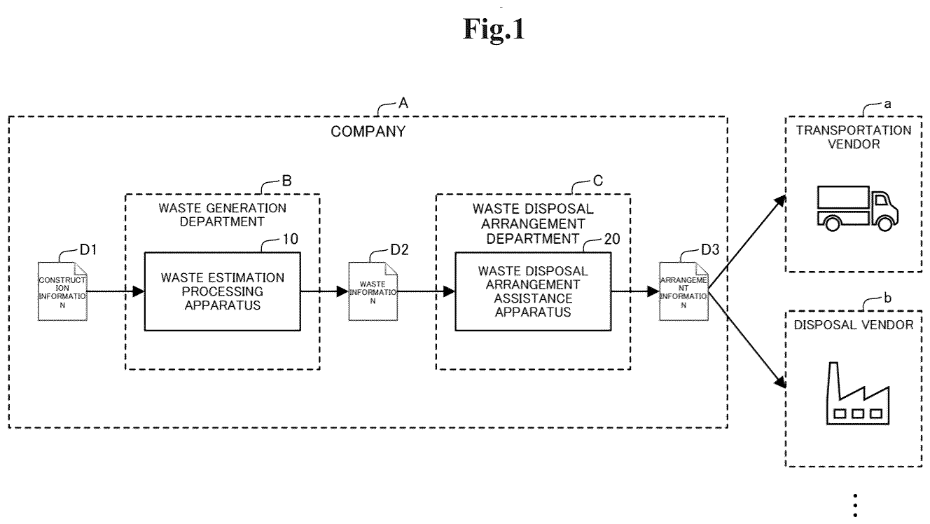

An information processing system in the present disclosure includes a function to realize estimating waste that may be generated as a result of execution of a work that may generate waste and assisting in the selection of a vendor to ask to dispose of the generated waste. As an example, in this example embodiment, as shown in FIG. 1, assuming a case where construction such as office expansion or renovation is carried out by a certain department B in a company A as the work that may generate waste described above, the system estimates waste that may be generated in the construction, and further assists in the selection and arrangement of vendors a, b, . . . to ask to 10 dispose of the waste by another department C in the company A. At this time, a department that may generate waste by carrying out construction is defined as a waste generation department B, and the waste is estimated using a waste estimation processing apparatus 10 that estimates waste. Moreover, a department to which the waste generation department B applies for waste disposal is defined as a waste disposal arrangement department C, and the selection of a vendor to ask to dispose of the waste using a waste disposal arrangement assistance apparatus 20.

The estimation of waste and the selection of a vendor described above are not necessarily limited to being performed in the same company A. That is to say, the waste estimation processing apparatus 10 and the waste disposal arrangement assistance apparatus 20 are not limited to being used in the same company A. Therefore, the waste estimation processing apparatus 10 and the waste disposal arrangement assistance apparatus 20 may be used in separate situations. For example, as will be described later, the waste estimation processing apparatus 10 may be used only for estimating waste from information on certain construction, and the waste disposal arrangement assistance apparatus 20 may be used not for an application for waste disposal based on information on the waste estimated by the waste estimation processing apparatus 10, but for the selection of a vendor for another application for waste disposal.

Further, in this example embodiment, construction such as office expansion or renovation will be described as an example of a work that may generate waste, but the work that may generate waste may also be a work that does not involve construction, such as moving work, manufacturing in a manufacturing plant, and demolition work, and includes any work that may generate waste.

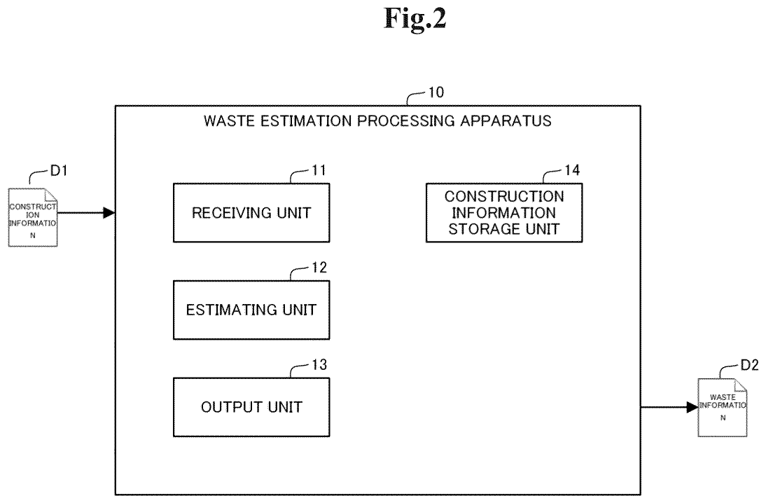

First, the waste estimation processing apparatus 10 will be described. The waste estimation processing apparatus 10 is configured with one or a plurality of information processing apparatuses each including an arithmetic logic unit and a memory unit. Then, as shown in FIG. 2, the waste estimation processing apparatus 10 includes a receiving unit 11, an estimating unit 12, and an output unit 13. The respective functions of the receiving unit 11, the estimating unit 12, and the output unit 13 can be realized by execution of a program for realizing the respective functions stored in the memory unit by the arithmetic logic unit. The waste estimation processing apparatus 10 also includes a construction information storage unit 14. The construction information storage unit 14 is configured with the memory unit. The respective components will be described in detail below.

The receiving unit 11 receives input of construction information D1 that contains information representing the details of construction that may generate waste, from a person in charge in the waste generation department B. For example, the construction information D1 is information included by a construction plan and, as an example, the construction information D1 is information included by a construction ledger, a process chart, an estimate, information on construction site, and the like. To be specific, the construction ledger includes estimation information of material cost, labor cost, outsourcing cost, expenses, and so forth. The process chart is information representing a plan for construction, and includes information representing a work status such as construction period, work details, and so forth. Moreover, the estimate includes information such as construction period, delivery date, construction overview, and construction breakdown. The information on construction site is information such as the geology of construction site, weather at the time of construction, and photos taken of the site before and during construction. Thus, as described above, the construction information D1 includes the work details of the construction, the material cost, the photos of the site, and so forth, and includes information on the dimensions, shapes, contextures and materials used of a structure before demolition in the construction, and information on materials newly used in the construction. Consequently, by using the construction information D1, it is possible to estimate waste that may be generated by construction as will be described later. In addition, the construction information D1 is not limited to information representing the details of a work such as the abovementioned construction, and may be information representing the details of a work that does not involve construction, such as moving work, manufacturing work, and demolition work (work information). For example, the work information representing moving work includes information on waste that may be disposed of by moving, and the work information representing manufacturing work includes information on a manufacturing process and information on waste that may be generated by manufacturing.

Then, the receiving unit 11 stores the construction information D1 described above into the construction information storage unit 14. The construction information D1 may be structured based on a prepared rule or by using a large language model (LLM), an image recognition algorithm or the like. To be specific, the LLM extracts information from the construction information D1 and complements peripheral information thereof, and the image recognition algorithm estimates the volume, material and so forth of each material from image information of the construction information D1 and fills in numerical values representing a degree to which each material is used, thereby organizing the information as table data. However, the above is an example of the structuring of the construction information D1, which is not limited thereto. The received construction information D1 is used for a waste estimation process as will be described later, but in a case where the receiving unit 11 determines that the received construction information D1 is insufficient based on a preset criterion, the receiving unit 11 requests a person in charge in the waste generation department B to provide shortfall in information, and receives input of the construction information D1 input in response to the request. For example, in a case where a construction ledger and a process chart are required as the construction information D1, when either one of the information is insufficient, the receiving unit 11 requests the other information.

The estimating unit 12 estimates waste generated by construction based on the construction information D1 input as described above. At this time, the estimating unit 12 estimates the type of waste and the amount of waste for each type.

To be specific, the estimating unit 12 inputs the construction information D1 into an estimation model created by machine learning in advance, and thereby sets the type of waste and the amount of waste for each type output from the estimation model as the result of estimation. For example, the type of machine learning includes linear regression, logistic regression, support vector machine (support vector regression), decision tree, random forest, neural network, k-neighbor method, Gaussian process, and the like. However, they are examples and the type of machine learning is not limited thereto. Then, for example, the type of waste estimated includes waste plastic, metal scrap, concrete waste, and the like. At this time, as the type of waste, the possibility of containing hazardous materials such as asbestos may be estimated by the percentage (%) of the possibility. In addition, weight (kg), volume (m³), and the like are estimated as the amount of waste for each type. As an example, the estimating unit 12 estimates waste in the following manner.
1. Scrap metal: weight: XX kg, volume XXm³
2. Concrete waste: weight: YY kg, volume YYm³
Total. weight ZZkg, volume ZZm³
*Possibility of hazardous material containment
   Possibility of containing asbestos: 20%

Further, the estimating unit 12 may express as a waste transportation requirement, namely, the loading amount of a transporting truck, based on the amount of waste for each type estimated as described above. To be specific, the estimating unit 12 may estimate, as the transportation requirement, the selection of a vehicle that can transport the amount of waste and a loading rate as a loading status when the waste is loaded into the vehicle. For example, the estimating unit 12 previously stores information on weight and volume that can be loaded for each type of vehicle, selects the type of a vehicle that can load the estimated weight and volume of waste, and further calculates the ratio of the volume of waste to the volume that can be loaded on the selected vehicle. Consequently, the estimating unit 12 can calculate and estimate, from the estimated weight and volume of waste, information such as “one 4-t truck (loading rate: 70%)” and “one 2-t UNIC vehicle (loading rate: 80%)” as the transportation requirement. The case of calculating the loading rate as the waste loading status with respect to the vehicle is illustrated, but the estimating unit 12 may calculate, as the loading status, the extra loading amount, that is, the remaining loading amount or the remaining loading rate after the waste is loaded on the vehicle.

1. Scrap metal: weight: XX kg, volume XXm³, loading capacity XX %

Here, the estimation model described above is created by learning of learning data in which the prepared construction information D1 and information on waste (type and amount) are paired. To be specific, the learning data is data including a pair of the construction information D1 in a past construction case and the type and amount of waste actually generated in the construction case. In addition, the learning data is not limited to data generated from an actual construction case, and may be data generated by simulations or the like. Then, the estimation model is created by learning so as to minimize the error between an output estimated using the construction information D1 that is the learning data as an input and the type and amount of waste that is the training data to be the true output.

However, the estimating unit 12 is not necessarily limited to estimating waste from the construction information D1 by using the estimation model, and may estimate by another method. For example, the estimating unit 12 may have a preset calculation formula for calculating the type and amount of waste using information included by the construction information D1 as a parameter and estimate waste using the calculation formula. At this time, as described above, the construction information D1 includes the work details of construction, material cost, photos of the site and the like, and it is possible to estimate by a calculation formula for estimating waste by using the above information. For example, since the work details of construction also include information such as the dimensions, shape, structure, installations, materials used and so forth of a room before demolition, it is possible to estimate the type and amount of waste that may be generated after demolition from the above information.

The output unit 13 (estimating unit) outputs information on the type and amount of waste estimated in the above manner, as waste information D2. Consequently, a person in charge in the waste generation department B can accurately grasp the type and amount of waste that may be generated by construction and, based on the above information, can make an application for waste disposal requesting waste disposal to the waste disposal arrangement department C. At this time, a waste disposal application to the waste disposal arrangement department C is made by submitting a waste disposal application form, but the output unit 13 may generate at least part of the waste disposal application form. For example, electronic data to be the format of the waste disposal application form is prepared, and the estimated waste type, weight, and volume data may be input into fields for inputting the type, weight, and volume of waste in the waste disposal application form, and the waste disposal application form may be created and output.

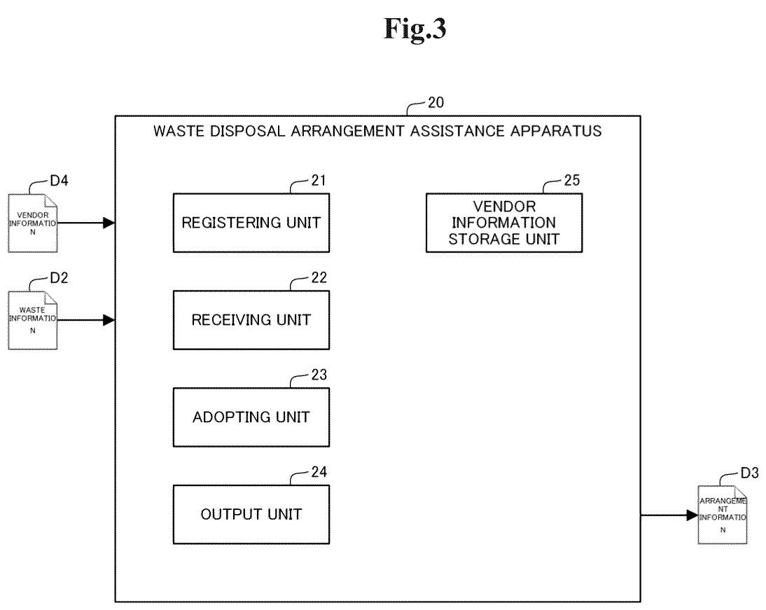

Next, the waste disposal arrangement assistance apparatus 20 will be described. The waste disposal arrangement assistance apparatus 20 is configured with one or a plurality of information processing apparatuses each including an arithmetic logic unit and a memory unit. Then, as shown in FIG. 3, the waste disposal arrangement assistance apparatus 20 includes a registering unit 21, a receiving unit 22, an adopting unit 23, and an output unit 24. The respective functions of the registering unit 21, the receiving unit 22, the adopting unit 23, and the output unit 24 can be realized by execution of a program for realizing the respective functions stored in the memory unit by the arithmetic logic unit. Moreover, the waste disposal arrangement assistance apparatus 20 includes a vendor information storage unit 25. The vendor information storage unit 25 is configured with the memory unit. The respective components will be described in detail below.

The registering unit 21 receives input of vendor information, which is information of a vendor that conducts business related to waste disposal, from a person in charge in the waste disposal arrangement department C, and stores and registers it in the vendor information storage unit 25. For example, vendor information D4 is information included in a permit that is a certificate showing that a vendor is authorized by a predetermined agency to conduct business related to waste, a contract representing that a vendor has received a request from the company A to conduct business related to waste. To be specific, the permit includes the name of a vendor and business category information representing a vendor category corresponding to the business details of the vendor, and the registering unit 21 registers the name of the vendor and the business category information as the business information D4. As an example of the vendor category information, as shown in FIG. 1, there are categories such as a gather and transportation vendor a that conducts business of transporting waste and a disposal vendor b that conducts business of disposing waste, and these categories are registered. In addition to the abovementioned categories, a category of a removal vendor that conducts business of removing waste from a construction site may also be set as the vendor category information, and other categories may also be set.

Further, the permit includes item information representing waste that the vendor is permitted to handle in conducting the business, and the registering unit 21 registers the item information as the vendor information D4. The item information includes information such as waste plastic, metal scrap, and concrete waste, which are the types of waste described above, and such types of waste are registered. In addition, the item information may include information on how to dispose of waste. Moreover, the permit includes location information representing an area where the vendor is permitted to conduct the business and an address of the vendor itself, and duration information representing a duration that the vendor is permitted to conduct the business, and the registering unit 21 registers the location information and the duration information as the vendor information D4.

Further, the contract includes contract duration information representing a contract duration in which the vendor receives a business request from the company A, and the registering unit 21 registers the contract duration information as the vendor information D4. In addition, the registering unit 21 automatically renews and registers the duration after the expiration of the duration according to the registered contract duration information unless as far as there is no amendment or deletion of the contract duration information.

Further, the registering unit 21 registers, as the vendor information D4, not only the information included by the permit and the contract described above, but also the details of an interview conducted with the vendor by the person in charge in the waste disposal arrangement department C. At this time, the person in charge in the waste disposal arrangement department C particularly asks about characteristics associated with the implementation of the business by the vendor. For example, the characteristics of the vendor include preset indexes such as cost for performing the business (e.g., cost per unit of waste), recycling rate (e.g., ratio of recycled amount per unit of waste), CO² emissions (e.g., amount of CO² emitted per unit of waste), and an environmental index (e.g., preset scoring of the recycling rate vs. CO² emissions). Moreover, the characteristics of the vendor include information on trucks owned (e.g., type, size, number of trucks), operating hours, and throughput (e.g., throughput per day). The registering unit 21 registers these characteristics as the vendor information D4 in accordance with input from the person in charge in the waste disposal arrangement department C. In addition, information such as the location and the duration obtained from the permit and the contract mentioned above can also be said to be the characteristics of the vendor.

In addition, as described above, the registering unit 21 may register not only the information of the vendor that has received a business request from the company A and has contracted, but also the vendor information D4 described above of a vendor that has not contracted. In this case, the registering unit 21 may register information included in a permit and information acquired by an interview as the vendor information D4 in the same manner as described above.

Further, the registering unit 21 is not limited to acquiring the vendor information D4 from a permit, an interview and the like and storing into the vendor information storage unit 25 as described above, and may acquire the vendor information D4 from an external device and store into the vendor information storage unit 25. Moreover, the vendor information D4 may be stored in the vendor information storage unit 25 in advance, and the vendor information storage unit 25 may be configured with a storage device of an external device connected to the waste disposal arrangement assistance apparatus 20.

The receiving unit 22 receives input of waste information D2 representing the details of waste included in a disposal application form from a person in charge in the waste generation department B. At this time, the waste information D2 to be received includes data on the type, weight and volume of waste. Moreover, the waste information D2 includes waste discharge location information, that is, information on a location where construction that may generate discharges has been carried out. Moreover, the waste information D2 includes request information representing a request associated with waste disposal by the company A itself that disposes of waste, the waste generation department B, or the waste disposal arrangement department C. The request information is a request for a preset index associated with the execution of business by a vendor, such as the cost for waste disposal by the vendor, the recycling rate in the waste disposal by the vendor, the amount of CO² that may be generated in the waste disposal by the vendor, and the disposal time including the desired date and time of disposal. For example, in a case where the company A or the like that requests the disposal of waste places the highest priority on the cost, the request information is that the cost is low, in a case where the recycling rate is given the highest priority, the request information is that the recycling rate is high, in a case where CO² emissions are given the highest priority, the request information is that CO² emissions are low, and in a case where waste the date and time of waste disposal are given the highest priority, the request information is that the scheduled completion date and time of waste disposal is close to the disposal date and time.

The receiving unit 22 receives input of a disposal application form in a prepared format of electronic data, and acquires the data on the type, weight and volume of waste, the discharge location information, and the request information from preset description fields in the disposal application form, thereby receiving input of the waste information D2. However, the receiving unit 22 may receive, as the waste information D2, the data on the type, weight and volume of waste, the discharge location information, and the request information that are directly input by a person in charge in the waste generation department B into the waste disposal arrangement assistance apparatus 20.

The adopting unit 23 adopts a vendor to ask to dispose of waste included in the received waste information D2 described above based on the vendor information D4 stored and registered in the vendor information storage unit 25 as described above. At this time, the adopting unit 23 adopts a vendor that can handle disposal of waste included in the waste information D2. To be specific, the adopting unit 23 first examines the type of waste included in the waste information D2 and the type of waste that a vendor can handle from the item information included in the vendor information D4, and adopts a vendor that can handle the type of waste included in the waste information D2. For example, in a case where the type of waste included in the waste information D2 is “iron scrap”, a vendor permitted to execute business related to waste “iron scrap” is adopted.

At this time, the adopting unit 23 adopts a combination of a gather and transportation vendor and a disposal vendor based on business classification information included in the vendor information D4. That is to say, the adopting unit 23 adopts a gather and transportation vendor that performs business of transporting waste and a disposal vendor that performs business of waste disposal, respectively, and adopts a combination thereof. In addition to this, the adopting unit 23 may also set a removal vendor that removes waste from a discharge location, but in this example embodiment, a case of adopting a combination of a gather and transportation vendor and a disposal vendor will be described. A specific process to output the combination will be described later.

Then, when adopting a combination of a gather and transportation vendor and a disposal vendor, the adopting unit 23 adopts based on the discharge location information included in the waste information D2 and the vendor location information included in the vendor information D4. As an example, the adopting unit 23 may adopt a gather and transportation vendor that an area where the vendor is permitted to perform business includes a waste discharge location represented by the discharge location information, or a disposal vendor that a removal location is closer. At this time, the adopting unit 23 may adopt a plurality of gather and transportation vendors that relay waste in accordance with areas where the vendors are permitted to perform business.

Furthermore, when adopting a combination of a gather and transportation vendor and a disposal vendor, the adopting unit 23 adopts based on the request information included in the waste information D2 and each index representing the characteristic of a vendor included in the vendor information D4. As an example, in a case where the request information represents “cost first”, the adopting unit 23 examines the cost for performing business by a vendor, and adopts a combination with a low total cost from among the combinations of gather and transportation vendors and disposal vendors. Moreover, also in a case where the request information represents “recycling rate first” or “CO² emissions first”, the adopting unit 23 examines the recycling rate or the CO² emissions associated with the execution of business by a vendor, and adopts a combination with a high recycling rate or low CO² emissions from among the combinations of gather and transportation vendors and disposal vendors. At this time, the adopting unit 23 is not limited to adopting one combination, and may adopt a plurality of combinations, and may set the adoption priority order.

Further, when adopting a combination of a gather and transportation vendor and a disposal vendor, the adopting unit 23 adopts based on the weight and volume of waste included in the waste information D2 and information representing the characteristic of a vendor included in the vendor information D4. As an example, the adopting unit 23 examines information on a truck owned by a vendor included in the vendor information D4, and adopts a combination including a gather and transportation vendor that can transport waste with the weight and volume included in the waste information D2. At this time, for example, in a case where a throughput or the like is registered as the characteristic of a disposal vendor, the adopting unit 23 adopts a combination including a disposal vendor capable of disposing of waste with the weight and volume included in the waste information D2.

When adopting a combination of a gather and transportation vendor and a disposal vendor, the adopting unit 23 may adopt a combination including only vendors having contracted with the company A, but may also adopt a combination including a vendor that has not contracted with the company A. In this case, the adopting unit 23 may include information representing whether or not the vendor included in the combination has contracted with the company A in the combination information.

The adopting unit 23 may assign priority orders to the combinations of gather and transportation vendors and disposal vendors adopted as described above and further adopt a predetermined number of combinations. At this time, the score of each combination may be calculated based on a preset rule, and an adoption priority order may be set in order of score. For example, when adopting a combination as described above, a score may be given higher as the distance between the disposal vendor and the removal location is closer, a score may be given higher in order of best for indexes such as cost designated in the request information, and a score may be given higher to a vendor having contracted with the company A than to a vendor that has not contracted with the company, thereby calculating an overall score of each combination.

The output unit 24 outputs the combinations of gather and transportation vendors and disposal vendors adopted as described above. For example, the output unit 24 outputs one or a plurality of adopted combinations of gather and transportation vendors and disposal vendors, as arrangement information D3 so that a person in charge in the waste disposal arrangement department C can view. At this time, in a case where priority orders are set to adopt a plurality of combinations as described above, the output unit 24 may output the priority orders and the calculated scores together. Furthermore, the output unit 24 may output information calculated when adopting the combination, for example, the value of an index calculated based on the characteristic of a vendor in accordance with the request information of the company A or the like, such as the cost or the recycling rate. Moreover, the output unit 24 may output information representing whether or not the vendor included in the combination has contracted with the company A together.

An example of a specific process to output the combination will be described. As a problem of combination in the present invention, two types will be considered: “constraint” that is a rule which must be observed, and “objective function” that is a score which should be maximized or minimized. Here, constraint refers to that the type of waste that can be disposed of is determined for each vendor, and the objective function refers to the cost or the recycling rate. In a case where the number of combinations is small enough and all the patterns can be tried, it is possible to find the most appropriate combination by calculating whether all the patterns meet the constraint and what the score is at that time. On the other hand, in a case where the number of combinations is enormous, it is not practical to list all the patterns. Then, the most appropriate combination may be efficiently found using a mathematical optimization technology that considers the constraint and the objective function described above. Here, the mathematical optimization technology refers to, for example, linear programming, integer programming, mixed integer linear programming, non-linear programming, or genetic algorithm, particle swarm optimization, and the like. In addition, in a case where there are a plurality of types of scores, which are objective functions, it is no longer obvious which combination is best. In this case, there are two possible ways. The one of them is a method in which the user quantitatively determines the importance of each of the scores and then aggregates as one “total score”. In a case where the total score is one type of objective function, the optimal combination can be obtained by the aforementioned total search, or by mathematical optimization techniques. The other is to list all combinations where each of the scores is a trade-off. Conversely, it is to exclude all combinations that are not in a trade-off relation. After the enumeration, the purpose is for the user to adopt according to some criteria. When there are a plurality of such objective functions, they belong to a field called multi-objective optimization, thus this multi-objective optimization technique may be used. To be specific, there are branch-and-bound methods, genetic algorithms, metaheuristics, and the like. However, these processes are examples and the type of process is not limited thereto.

Consequently, the person in charge in the waste disposal arrangement department C can refer to the output combinations of gather and transportation vendors and disposal vendors to determine a combination of a gather and transportation vendor and a disposal vendor to ask to dispose of waste, and then ask these vendors to dispose of waste.

### Operation

Next, the operation of the above information processing system will be described. First, the operation of estimating waste that may be generated as a result of the implementation of construction by the waste estimation processing apparatus 10 will be described.

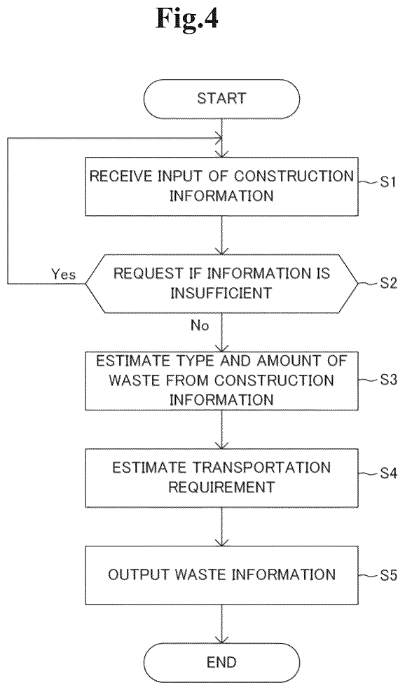

First, the waste estimation processing apparatus 10 receives input of construction information D1 including information representing the details of target construction (work) that may generate waste from a person in charge in the waste generation department B (step S1 of FIG. 4). For example, the construction information D1 is information included in a construction plan and, as an example, the construction information D1 is information included in a construction ledger, a process chart, an estimate, information on a construction site, and the like. At this time, in the case of determining that the received construction information D1 is insufficient based on a preset criterion (Yes at step S2 of FIG. 4), the waste estimation processing apparatus 10 requests the person in charge in the waste generation department B to provide a shortfall in information, and receives input of the construction information D1 input in response to the request (step S1 of FIG. 4).

Subsequently, the waste estimation processing apparatus 10 estimates waste generated by construction based on the input construction information D1 (step S3 of FIG. 4). At this time, the waste estimation processing apparatus 10 estimates the type of waste and the amount for each type of waste. For example, the waste estimation processing apparatus 10 inputs the construction information D1 into an estimation model machine-learned in advance, and thereby regards the type of waste and the amount for each type of waste output by the estimation model as an estimation result. For example, the type of waste estimated includes waste plastic, metal scrap, and concrete waste, and the amount for each type of waste estimated includes weight (kg) and volume (m³) thereof.

Furthermore, the waste estimation processing apparatus 10 estimates a waste transportation requirement based on the estimated amount for each type of waste (step S4 of FIG. 4). For example, the waste estimation processing apparatus 10 estimates, as the transportation requirement, the adoption of a vehicle that can transport the amount of waste and a loading rate as a loading status when the waste is loaded on the vehicle.

Then, the waste estimation processing apparatus 10 outputs information on the estimated type and amount of waste as waste information D2 (step S5 of FIG. 4). Consequently, the person in charge in the waste generation department B can accurately grasp the type and amount of waste that may be generated by construction and, based on the above information, can submit a disposal application for requesting the disposal of waste to the waste disposal arrangement department C.

Subsequently, the operation of assisting in adoption of a vendor to ask to dispose of generated waste by the waste disposal arrangement assistance apparatus 20 will be described.

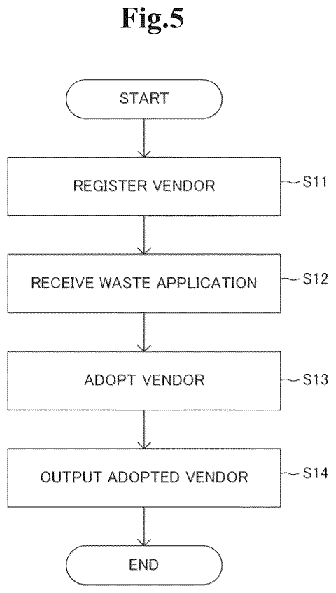

First, the waste disposal arrangement assistance apparatus 20 registers vendor information (step S11 of FIG. 5). For example, vendor information D4 includes business category information such as a gather and transportation vendor and a disposal vendor, item information representing waste that the vendor can handle, and location information representing a location that the vendor can handle. Furthermore, the vendor information D4 includes a preset index such as cost for performing business by the vendor, and characteristic information such as information on a truck owned.

Subsequently, the waste disposal arrangement assistance apparatus 20 receives input of the waste information D2 that is information on waste that the company A desires to be disposed of (step S12 of FIG. 5). At this time, the waste information D2 to be received includes data on the type, weight and volume of waste, waste discharge location information, and request information representing a request related to the disposal of waste.

Subsequently, the waste disposal arrangement assistance apparatus 20 adopts a vendor to ask to dispose of the waste included in the received waste information D2 based on the registered vendor information D4 (step S13 of FIG. 5). To be specific, the waste disposal arrangement assistance apparatus 20 adopts a combination of a gather and transportation vendor and a disposal vendor that can dispose of waste of a type included in the waste information D2. At this time, the waste disposal arrangement assistance apparatus 20 adopts based on location information including a waste discharge location and an area permitted for the vendor, indexes (cost, recycling rate, etc.) representing request information of the company A and the characteristic of the vendor, and so forth.

After that, the waste disposal arrangement assistance apparatus 20 outputs the adopted combination of gather and transportation vendor and disposal vendor (step S14 of FIG. 5). At this time, the waste disposal arrangement assistance apparatus 20 outputs one or a plurality of adopted combinations of gather and transportation vendors and disposal vendors so that a person in charge in the waste disposal arrangement department C can view. Consequently, the person in charge in the waste disposal arrangement department C can refer to the output combinations of gather and transportation vendors and disposal vendors to determine a combination of gather and transportation vendor and disposal vendor to ask to dispose of the waste, and then ask these vendors to dispose of the waste.

### Second Example Embodiment

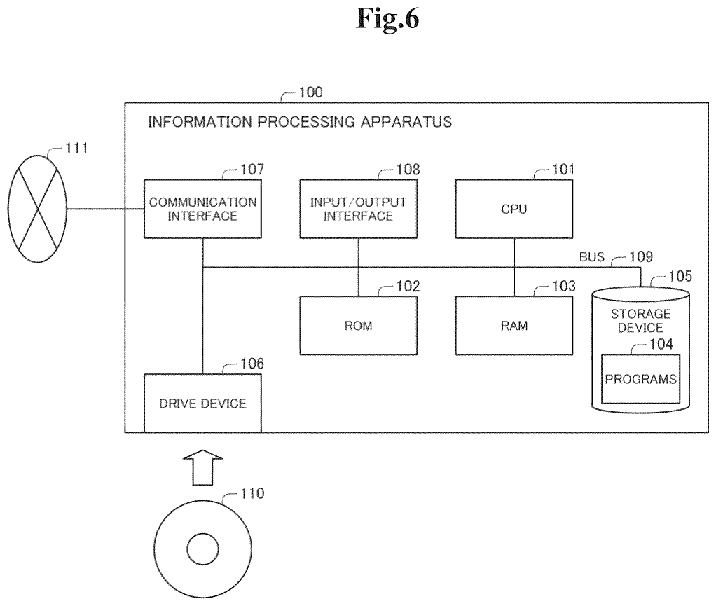

Next, a second example embodiment of the present disclosure will be described with reference to the drawings. In this example embodiment, the overview of the configurations of the waste estimation processing apparatus 10 and the waste disposal arrangement assistance apparatus 20 described in the above example embodiment will be shown. FIGS. 6 to 8 are diagrams for describing the configurations, and these drawings may be associated with any of the example embodiments.

First, a hardware configuration of an information processing apparatus 100 will be described with reference to FIG. 6. The information processing apparatus 100 is configured with a general information processing apparatus and, as an example, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 6 shows an example of the hardware configuration of the information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

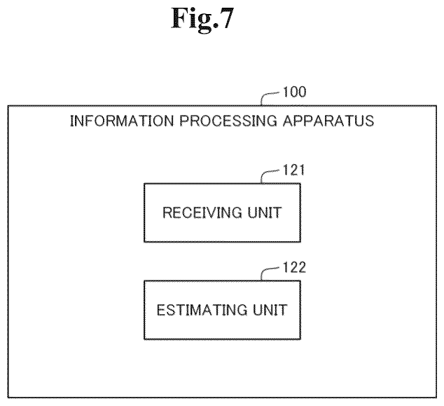

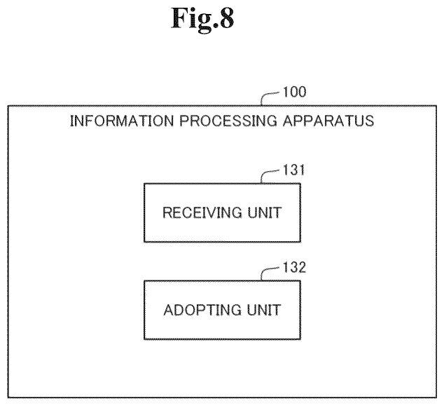

Then, the information processing apparatus 100 can construct and include a receiving unit 121 and an estimating unit 122 shown in FIG. 7 by acquisition and execution of the programs 104 by the CPU 101. Moreover, the information processing apparatus 100 can construct and include a receiving unit 131 and an adopting unit 132 shown in FIG. 8 by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the receiving unit 121, the estimating unit 122, the receiving unit 131, and the adopting unit 132 described above may be constructed using dedicated electronic circuits for realizing such means.

The receiving unit 121 receives input of work information including information representing the details of a work that may generate waste. The estimating unit 122 estimates waste generated by the work based on the work information.

Further, the receiving unit 131 receives input of waste information representing the details of waste. The adopting unit 132 adopts a vendor to ask to dispose of the waste included by the waste information based on vendor information including information on the details of business of a vendor that performs business related to disposal of waste.

With the configuration as described above, the present disclosure enables accurate recognition of waste that may be generated by a work from the work information. As a result, submission of a disposal application for requesting the disposal of waste is facilitated, and it is possible to smoothly perform the disposal of waste.

Moreover, with the configuration as described above of the present disclosure, a vendor to ask to dispose of waste is adopted based on the vendor information and the waste information. As a result, it is facilitated to determine and request a vendor to ask to dispose of waste, and it is possible to smoothly perform the disposal of waste.

In addition, at least one or more of the functions of the receiving unit 121 and the estimating unit 122, and at least one or more of the functions of the receiving unit 131 and the adopting unit 132 may be performed by an information processing apparatus installed and connected anywhere on the network, that is, may be performed by so-called cloud computing.

Further, the abovementioned programs can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), read only memory (CD-ROM), CD-R, CD-R/W, semiconductor memory (e.g., mask ROM, programmable ROM, Erasable PROM, flash ROM, random access memory (RAM)). In addition, a program may be provided to a computer by various types of temporary computer-readable medium. Examples of temporary computer-readable medium include electrical signals, optical signals, and electromagnetic waves. The temporary computer-readable medium may provide a program to the computer via a wired communication channel, such as an electric wire and an optical fiber, or a wireless communication channel.

Although the present disclosure has been described above with reference to the above-described example embodiments, the present disclosure is not limited to the embodiments described above. The configuration and details of the present disclosure can be changed in a variety of ways that those skilled in the art can understand within the scope of the present disclosure. Then, each of the example embodiments described above can be combined with the other example embodiment as necessary.

### Supplementary Notes

The whole or part of the example embodiments disclosed above can be described as the following supplementary notes. Below, the overview of the configurations of the information processing apparatus, the information processing method, and the program will be described. However, the present disclosure is not limited to the following configurations.

### Supplementary Note 1

An information processing apparatus comprising:
a receiving unit that receives input of work information including information representing details of a work that may generate waste; and
an estimating unit that estimates waste generated by the work based on the work information.

### Supplementary Note 2

The information processing apparatus according to Supplementary Note 1, wherein: the receiving unit receives input of the work information including information representing a plan of the work; and the estimating unit estimates the waste based on the information representing the plan of the work included by the work information.

### Supplementary Note 3

The information processing apparatus according to Supplementary Note 1, wherein:
the receiving unit receives input of the work information including information representing a cost of the work; and
the estimating unit estimates the waste based on the information representing the cost of the work included by the work information.

### Supplementary Note 4

The information processing apparatus according to Supplementary Note 1, wherein:
the receiving unit receives input of the work information including information on a site of the work; and
the estimating unit estimates the waste based on the information on the site of the work included by the work information.

### Supplementary Note 5

The information processing apparatus according to Supplementary Note 1, wherein
the estimating unit estimates a type of the waste based on the work information.

### Supplementary Note 6

The information processing apparatus according to Supplementary Note 5, wherein
the estimating unit estimates an amount for each type of the waste based on the work information.

### Supplementary Note 7

The information processing apparatus according to Supplementary Note 6, wherein
the estimating unit estimates a requirement for transporting the waste based on the amount for each type of the waste.

### Supplementary Note 8

The information processing apparatus according to Supplementary Note 7, wherein
the estimating unit estimates a loading status of the waste onto a vehicle transporting the waste based on the amount for each type of the waste.

### Supplementary Note 9

The information processing apparatus according to Supplementary Note 1, wherein
the estimating unit generates preset information to be used for disposing of the waste based on the estimated waste.

### Supplementary Note 10

An information processing method by an information processing apparatus, the information processing method comprising:
receiving input of work information including information representing details of a work that may generate waste; and
estimating waste generated by the work based on the work information.

### Supplementary Note 11

A program comprising instructions for causing a computer to execute processes to:
receive input of work information including information representing details of a work that may generate waste; and
estimate waste generated by the work based on the work information.

### Supplementary Note A1

An information processing apparatus comprising:
a receiving unit that receives input of waste information representing details of waste; and
an adopting unit that adopts a vendor to ask to dispose of the waste included by the waste information based on vendor information including information on details of business of a vendor that performs business related to disposal of waste.

### Supplementary Note A2

The information processing apparatus according to Supplementary Note A1, wherein:
the vendor information includes information on waste that the vendor can handle; and
the adopting unit adopts the vendor that can handle disposal of the waste included by the waste information, based on the vendor information.

### Supplementary Note A3

The information processing apparatus according to Supplementary Note A1, wherein:
the vendor information includes information on a preset characteristic of the vendor in disposal of waste; and
the adopting unit adopts the vendor based on the characteristic included by the vendor information.

### Supplementary Note A4

The information processing apparatus according to Supplementary Note A3, wherein:
the receiving unit receives request information representing a request associated with disposal by one that desires disposal of waste; and
the adopting unit adopts the vendor based on the request information and the characteristic included by the vendor information.

### Supplementary Note A5

The information processing apparatus according to Supplementary Note A4, wherein: the vendor information includes a value of a preset index associated with execution of the business by the vendor, as the characteristic of the vendor;
the receiving unit receives the request information including information that designates the index; and
the adopting unit adopts the vendor based on the designated index included by the request information and the value of the index included by the vendor information.

### Supplementary Note A6

The information processing apparatus according to Supplementary Note A3, wherein:
the vendor information includes information on a location where the vendor executes the business, as the characteristic of the vendor;
the receiving unit receives discharge location information representing a waste discharge location; and
the adopting unit adopts the vendor based on the discharge location information and information on a location where the vendor executes the business included by the vendor information.

### Supplementary Note A7

The information processing apparatus according to Supplementary Note A1, wherein:
the vendor information includes information representing that the details of the business of the vendor is transportation business of transporting waste or disposal business of disposing of waste; and
the adopting unit adopts a combination of the vendor that performs the transportation business and the vendor that performs the disposal business, based on the vendor information.

### Supplementary Note A8

The information processing apparatus according to Supplementary Note A7, wherein:
the vendor information includes information on a location where the vendor performs the business;
the receiving unit receives discharge location information representing a waste discharge location; and
the adopting unit adopts a combination of the vendor that performs the transportation business and the vendor that performs the disposal business based on the discharge location information and the vendor information.

### Supplementary Note A9

An information processing method by an information processing apparatus, the information processing method comprising:
receiving input of waste information representing details of waste; and
adopting a vendor to ask to dispose of the waste included by the waste information based on vendor information including information on details of business of a vendor that performs business related to disposal of waste.

### Supplementary Note A10

A program comprising instructions for causing a computer to execute processes to:
receive input of waste information representing details of waste; and
adopt a vendor to ask to dispose of the waste included by the waste information based on vendor information including information on details of business of a vendor that performs business related to disposal of waste.

### DESCRIPTION OF REFERENCE NUMERALS

10 waste estimation processing apparatus
11 receiving unit
12 estimating unit
13 output unit
14 construction information storage unit
20 waste disposal arrangement assistance apparatus
21 registering unit
22 receiving unit.
23 adopting unit
24 output unit
25 vendor information storage unit
100 information processing apparatus
101 CPU (Central Processing Unit)
102 ROM
103 RAM
104 programs
105 storage device
106 drive device
107 communication interface
108 input/output interface
109 bus
110 storage medium
111 communication network
121 receiving unit
122 estimating unit
131 receiving unit
132 adopting unit

1. An information processing apparatus comprising:
at least one memory storing processing instructions; and
at least one processor configured to execute the processing instructions,
wherein the at least one processor is configured to execute the processing instructions to:
receive input of work information including information representing details of a work that may generate waste; and
estimate waste generated by the work based on the work information.

2. The information processing apparatus according to claim 1, wherein the at least one processor is configured to execute the processing instructions to:
receive input of the work information including information representing a plan of the work; and
estimate the waste based on the information representing the plan of the work included by the work information.

3. The information processing apparatus according to claim 1, wherein the at least one processor is configured to execute the processing instructions to:
receive input of the work information including information representing a cost of the work; and
estimate the waste based on the information representing the cost of the work included by the work information.

4. The information processing apparatus according to claim 1, wherein the at least one processor is configured to execute the processing instructions to:
receive input of the work information including information on a site of the work; and
estimate the waste based on the information on the site of the work included by the work information.

5. The information processing apparatus according to claim 1, wherein the at least one processor is configured to execute the processing instructions to
estimate a type of the waste based on the work information.

6. The information processing apparatus according to claim 5, wherein the at least one processor is configured to execute the processing instructions to
estimate an amount for each type of the waste based on the work information.

7. The information processing apparatus according to claim 6, wherein the at least one processor is configured to execute the processing instructions to
estimate a requirement for transporting the waste based on the amount for each type of the waste.

8. The information processing apparatus according to claim 7, wherein the at least one processor is configured to execute the processing instructions to
estimate a loading status of the waste onto a vehicle transporting the waste based on the amount for each type of the waste.

9. The information processing apparatus according to claim 1, wherein the at least one processor is configured to execute the processing instructions to generate preset information to be used for disposing of the waste based on the estimated waste.

10. An information processing method by an information processing apparatus, the information processing method comprising:
receiving input of work information including information representing details of a work that may generate waste; and
estimating waste generated by the work based on the work information.
